(19) United States
(12) Patent Application Publication
(10) Pub. No.: US 2011/0055745 A1
(43) Pub. Date: Mar. 3, 2011

(54) ADOPTIVE MONITORING AND REPORTING OF RESOURCE UTILIZATION AND EFFICIENCY

(75) Inventors: Irene R. Penney, Poughkeepsie, NY (US); Carl J. Radens, Hopewell Junction, NY (US); Nancy M. Wei, Hawthorne, NY (US); Devon G. Williams, Hopewell Junction, NY (US)

(73) Assignee: INTERNATIONAL BUSINESS MACHINES CORPORATION, Armonk, NY (US)

(21) Appl. No.: 12/552,007

(22) Filed: Sep. 1, 2009

(51) Int. Cl. G06F 3/048; G06Q 10/00; G06Q 50/00

(52) U.S. Cl. 715/771; 705/7

(57) ABSTRACT

A system and method of generating for display on a computer device, a resource utilization and efficiency value of a residence or business comprises: monitoring at least one energy using device associated with the residence or business for obtaining operating data; analyzing the operating data obtained during a predetermined interval of time for obtaining a value of energy used by the at least one energy using device; calculating an efficiency value from the value of energy used during the predetermined interval of time; and using the efficiency value to create a computer generated image that represents the calculated efficiency value for a predetermined interval of time for display on the computer device.

### BACKGROUND

1. Field of the Invention

This invention relates generally to systems and methods to encourage and promote environmentally conscious behavior and more particularly, to a novel system and method for motivating individuals to modify their behavior to more fully embrace being greener by being more environmentally friendly.

2. Description of the Related Art

Many individuals in the United States and elsewhere believe that global warming is a current environmental problem, and that some action should be implemented to reduce the negative impact that pollution has on the environment. These individuals, however, have not been motivated to be “green” by modifying their use of energy operated appliances or creating less waste. Green is broadly defined as electing to conserve, rather than exploit, natural resources in exchange for benefits that compensate for the environmentally harmful activities.

Many activities of individuals, and the systems and services that support individuals, produce pollution of one or more types. Examples of pollution can include, but are not limited to, carbon emissions, e.g., carbon dioxide emissions and other pollutants, such as greenhouse gasses that are measured in carbon dioxide emission equivalents, NOx emissions, noise, light, waste, waste pollution, and combinations thereof. Many individuals have become aware of the negative impacts of the various types of pollutants and ways to minimize the impact of the pollutants on the environment.

Motivation plays a significant role in an individual's interest in continuously and productively following procedures that can result in more efficient energy usage.

One way of measuring the impact that pollution may have on the environment is by a carbon footprint. Carbon emission calculators that assist consumers in calculating their carbon emission footprint have appeared on the Internet. However, these calculators have not been successful at motivating individuals to modify the way they use energy.

The inability to provide information concerning energy conservation that associates a person's physical activities and habits to energy conservation results in an easily perceivable manner can limit the usefulness of conventional activity motivational techniques. As contemporary lifestyles have become increasingly fast paced and more complicated, the number of electronic devices carried by a person has increased. It is not uncommon for an individual to carry a cellular phone, a calculator, a pager, etc. The inconvenience of physically transporting such devices often results in eliminating certain devices such as an emission and energy measuring device.

Many individuals are interested, and willing, to modify their habits and do things differently to support something that they believe is correct, especially if they have a way to demonstrate their actions to their peers and receive positive feedback in doing so.

Many people are interested in reducing the amounts of green house gases and other pollutants generated and released into the environment, and would be willing to change the way they use energy, especially if they have a way to communicate and demonstrate to others how they are being “green”.

A need exists for improving motivational techniques that allow individuals to associate real life energy use with an individual's progress toward particular energy reduction goals.

### SUMMARY

The present invention is directed to systems and methods for using computer generated avatars and widgets, either separately or in combination, that provide indication to motivate an individual to conserve an energy resource and develop habits that are directed toward that end.

In an embodiment there is disclosed a computer-implemented method of indicating energy usage of an energy consuming device and, generating for display on a computer device, a resource utilization and efficiency value of a residence or business comprising:

monitoring at least one energy using device associated with an environment for obtaining operating data in a predetermined time interval;

analyzing said operating data obtained during said predetermined interval of time for obtaining a value of energy used by said at least one energy using device;

calculating an efficiency value from the value of energy used during the predetermined interval of time; and

creating, based on said efficiency value, a computer generated image that represents said calculated efficiency value for the predetermined interval of time for display on the computer screen,

using a processor to perform one or more of said analyzing, calculating and creating steps.

In another embodiment there is disclosed a system of generating for display of a computer device, a resource utilization and efficiency value of a residence or business comprising:

a sensor for monitoring at least one energy using device associated with said home for obtaining operating data;

means for analyzing said operating data obtained during a predetermined interval of time for obtaining a value of energy used by said at least one energy using device;

means for calculating an efficiency value from the value of energy used during the predetermined interval of time; and

means for using said efficiency value to create a computer generated image that represents said calculated efficiency value for a predetermined interval of time for display on the computer screen.

In another embodiment there is provided a computer program product for generating a display representing a resource utilization and efficiency value of a residence or business, the computer program product comprising:

a storage medium readable by a processing circuit and storing instructions for operation by the processing circuit for performing a method comprising:
monitoring at least one energy using device associated with an environment for obtaining operating data in a predetermined time interval;
analyzing said operating data obtained during said predetermined interval of time for obtaining a value of energy used by said at least one energy using device;
calculating an efficiency value from the value of energy used during the predetermined interval of time; and
creating, based on said efficiency value, a computer generated image that represents said calculated efficiency value for the predetermined interval of time for display on the computer screen.

The foregoing has outlined, rather broadly, the preferred feature of the present invention so that those skilled in the art may better understand the detailed description of the invention that follows. Additional features of the invention will be described hereinafter that form the subject of the claim of the invention. Those skilled in the art should appreciate that they can readily use the conception and specific embodiment as a base for designing or modifying the structures for carrying out the same purposes of the present invention and that such other features do not depart from the spirit and scope of the invention is its broadest form.

### BRIEF DESCRIPTION OF THE DRAWINGS

Other aspects, features, and advantages of the present invention will become more fully apparent from the following detailed description, the appended claims, and the accompanying drawings in which similar elements are given similar reference numerals.

FIG. 1 illustrates a system for acquiring real time green data and communicating the green data via a mobile terminal to a network server in accordance with an embodiment of the present invention;

FIG. 2 illustrates a system for acquiring various types of energy related data using sensor devices;

FIG. 3 is a flow chart of a method of acquiring and integrating green data into a virtual green model established for a user in accordance with an embodiment of the present invention;

FIG. 4 shows graphical green related data developed from acquired green data of a visual depiction of a user, i.e., avatar/widget, in various staged of values of green in accordance with an embodiment of the present invention; and

FIG. 5 is a block diagram of a computer system for use with the present invention.

### DETAILED DESCRIPTION

An “avatar”, as used herein, refers to the physical incarnation of an online user in a virtual reality world. The avatar may be a scanned image of the user's face, for example, or a more complicated computer-generated caricature for use by the virtual reality participant. Avatar-based chat rooms are examples of Internet-based multi-user systems in which relatively small numbers of simultaneous users communicate with each other over the Internet. For example, one computer generated virtual world can be found at ACTIVEWORLDS.COM which provides a realistic, 3-D virtual reality chat service in which virtual reality worlds are created and avatar-based caricatures correspond with each other in a 3-D graphical environment. “Virtual” is defined as that which is not real, but displays the full qualities of the real—in a plainly actual (i.e., not potential)—way.

As used herein, a “widget” may take the form of an entity, e.g., real or virtual, that can be represented on a display or media. For example, a widget may take the form of on-screen tool such as a clock, an event countdown, a symbol, a rising or falling thermometer, a weather condition, etc. A widget can be in a form that can be displayed on a social networking site, can be used in combination with avatars in virtual worlds, or be added to an e-mail signature, etc. A widget can also be a portable chunk of code that can be installed and operated within any separate HTML-based web page by an end user without requiring additional compilation. It can also be displayed on an electronic blackboard, a smartphone device such as a Blackberry, on a bumper sticker of t-shirt, or on some other media.

The present invention is directed to systems and methods for using computer generated avatars and widgets, either separately or in combination to motivate an individual to conserve energy and develop habits that are directed toward that end.

Systems and methods of the present invention provide for the generation of, and maintenance and modification to, a virtual model, referred to herein as an avatar and/or a widget, which represents an individuals' effectiveness in being green. The virtual model, in general, characterizes the effectiveness of an individual in being green by a thermometer, widget, icon, etc., that changes shape and/or tint or hue, or a face that changes from being happy to being sad based on the amount of energy that was not used and/or a reduction of waste produced by a user in real-time.

Employment of a visual depiction or characterization of a user's real time use of energy in accordance with the principles of the present invention provides a comprehensive visual physical feedback methodology heretofore unavailable using conventional green monitoring techniques.

Multiple device sources may be monitored for obtaining green data for a given user to provide_an accurate characterization and, therefore, understanding, of an individual's “greenness” in real-time and the effects of various new energy savings habits undertaken by an individual.

As such, an individuals every day activities can be developed and augmented over time to facilitate achievement of green goals. The accuracy by which the impact of following good green living of an individual is measured is significantly improved by employment of the system and method of the present invention. Further, by indicating, via a user's generated avatar or widget a reduction in the use of energy, a unique, entertaining, and real-life characterization of a user is provided, and an individual is further motivated to remain committed to improved green living.

By way of example, the method includes enabling an individual to create an avatar representative of the current green state of the user. The individual can adjust or change the appearance of the avatar to a more desired appearance that is reflective of a green value, i.e., a measure of a person's green state as measured by the monitoring techniques employed. For example, when an example avatar of a face is used, the anatomical dimensions of the avatar can be changed to reflect the shape of the mouth and the shape or size of the face. Given differences between the desired avatar features and present avatar features, various green producing habits are developed to help an individual achieve desired green goals. Green data subsequently acquired and applied for representation by the widget or avatar, and compared to a desired avatar's data, can be used to determine if the individual is effective in achieving his/hers desired green goals.

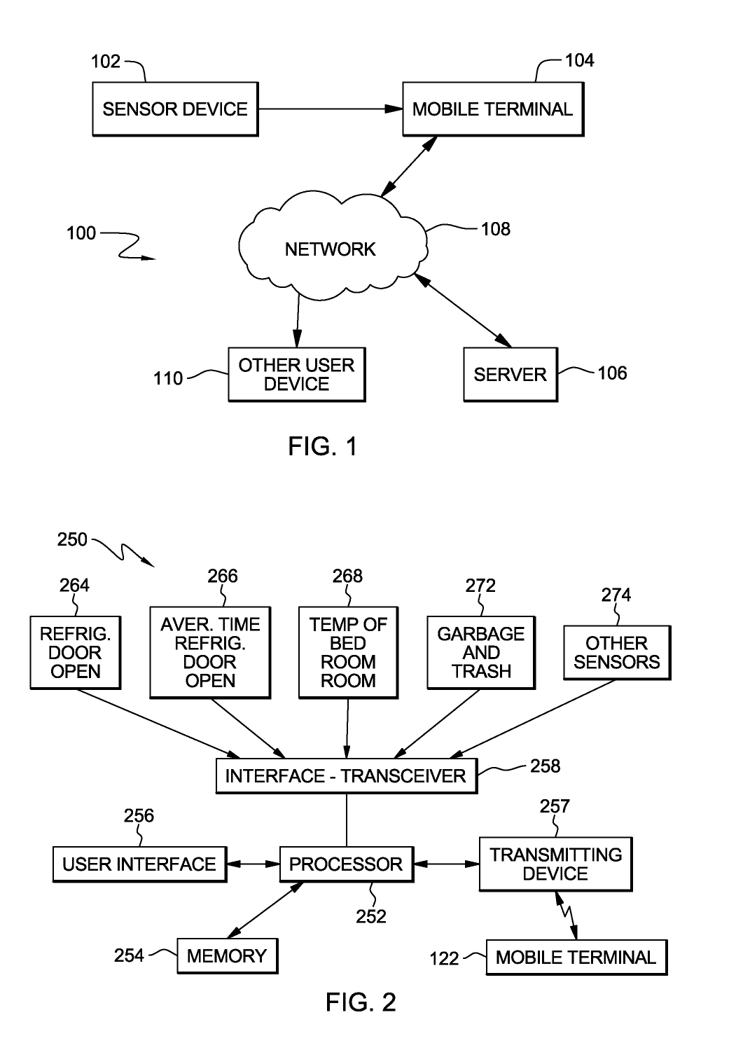

Referring to FIG. 1, there is illustrated a system 100 for acquiring and analyzing green data pertaining to an individual's use of devices, and communicating the green data, e.g., over a network via a mobile terminal to a network server, for integration into a virtual green model established for the individual in accordance with one embodiment of the present invention. In FIG. 1, one or more sensor device(s) 102 associated with a device(s) to be monitored for any activity impacting green-ness of the individual is coupled to a mobile terminal 104 via a wireless link. As further shown in FIG. 1, sensor device 102 represents one or more sensing devices that sense one or more green parameters of an electrically operated device (not shown), such as the number of times a refrigerator or freezer door is opened, the duration of time that the refrigerator door is left open, the temperature that a room thermostat is set at during a specific period such as from 12 midnight to 6 AM, etc.

As referred to herein, green data is data used to characterize the efficiency of energy and resource utilization). Green data can be obtained from a sensor device(s) 102. In a non-limiting example, green data can be categorized into several categories such as, for example, room cooling/heating, clothes washing, lighting, dish washing, cooking, water heating etc. Green data can be real time data or event driven and can also be static data (e.g., such as a refrigerator model number). Table 1 is an example table populated with example green data for storage in a memory system, e.g., a database, that could be used to measure a user's or device's greenness according to an aspect of the invention. The data includes particular categories such as target monitoring devices (refrigerator) or areas (room), and associated green data attributes, e.g., power consumption/time interval of a particular device, and associated measured units (e.g., watts/sec, watts/minutes, etc. The categories can be further representative of pollution impacting activities as well, e.g., driving, air travel.

TABLE 1

| Monitor target | Sensor: wired or wireless | Unit |
|---|---|---|
| Refrigerator Door open | Time and duration open | Time in seconds, minutes, etc. |
| Refrigerator | Power consumption/time interval | Watts per second, minutes, etc. |
| Dishwasher/Clothes | Load, torque, pressure | Grams, ounces, pounds, inch |
| Washer/Dryer | | pounds, etc. |
| Dishwasher/Clothes | Power consumption/time interval | Wattage per second, minutes, |
| Washer/Dryer | | etc. |
| Room | Room temperature | Celsius, Fahrenheit, etc. |
| Outdoor | Temperature | Celsius, Fahrenheit, etc. |
| Sleep | Sleep time and duration | Hours |
| Nobody in room | Motion detection | Yes or no |
| Hot water | Power consumption | Watts per second, minutes, etc. |
| Air conditioner | Power consumption/time | Watts per second, minutes, etc. |
| | interval | |
| Stove/Oven/microwave | Power consumption/time | Watts per second, minutes, etc. |
| | interval | |
| Automobile | Gas mileage | MPG |

Green (sensor) data can be further communicated to mobile terminal 104 and relayed to a server, e.g., server 106, or like network computer device, which is configured to accept and process this data, via a network 108, e.g., Internet, intranet, and public or other types of Local Area Network (e.g., LANs, PANs), etc. Server 106 stores and runs processing software that, in general, operates on the green data received from each of a number of sensor devices.

In operation, the server collects and stores data for a specified time period, e.g., 10 years. A software program is provided to configure a computing device, PC laptop, mobile, pervasive digital device, etc., or any device that has a processor, to invoke instructions for integrating and analyzing the data with statistical methods to provide comprehensive results, as well as make predictions of future use based on historical values. For example, the power consumption caused by opening the door of a refrigerator can be used to analyze and calculate the power consumption in a particular time interval, e.g., by week or month. All analysis results are configured to be displayed via widgets in charts, tables, lists, etc. Moreover, software operating on the server or other compute device, calculates the trends of the power consumption and creates the avatar based on the trends. In a non-limiting example, if the trend is down (reduced consumption), an avatar shown with a smiling face or a green sticker will be created, in an example embodiment. The analysis can also be conducted with comparison to the average number in other refrigerator models in a geographic area. The same method can also be applied to other appliances to capture an individual's behavior and the appliances' performance. The processing software integrates currently or recently acquired green data into an individual's virtual model (i.e., avatar and/or widget). The individual can review the data associated with his or her avatar/widget using mobile terminal 104 or other user display device 110.

Server 106 can also provide for the creation of an individual's avatar/widget for display on user's mobile or like computing device 104. In one embodiment, the user creates an account to use the service for creating/modifying avatars. The server provides a group of default avatars, as well as tools to let the user create a customized avatar, or import an avatar from another web site, email, social network, etc. It can be appreciated that the information associated with an individual's avatar/widget can be customized to that individual. As such, access to a person's avatar/widget and information associated with the avatar is subject to access restrictions, as defined in the user's account. For example, access rights to a person's avatar and related information are typically granted only to the person who can grant access rights at various security levels to others as desired.

The processing software can further compute green data of various types, including, but not limited to: temperature of a room relative to the outside temperature, length of time that light bulbs are on and the wattage of the bulbs, the number of times a dish washer, or a clothes washer and dryer are operated during a set period of time interval, e.g., during a week, day, hour, and/or other types of green data that can be sensed and monitored. Various types of green data, changes to such data over time, and various views of the user's avatar/widget can be embodied in the green data. The green data is sent from server 106 to the user via network 108. The green data can be sent to mobile terminal 104 or some other user device 110 for processing and/or display thereof.

Referring to FIG. 2, there is shown a number of sensor devices that can be employed in a green data system 250 of the present invention. It is understood that the devices depicted in FIG. 2 do not represent an exhaustive listing of devices that can be employed. Moreover, it is understood that green data system 250 need not incorporate all of the devices shown in FIG. 2, but can incorporate one or multiple devices.

According to one embodiment, green data acquisition system 250 represents a unit that acquires green data, e.g., from one or more sensor devices, that can be stored in a memory storage device (database). The sensor devices may be integral to or separate from green data acquisition system 250. Each green sensor device communicates with green data system 250 via a wireless connection, however, a hard wired connection may be implemented. The green data system 250 includes a local interface/transceiver 258 that transmits data to and receives data from each sensor. Depending on the type of sensor device employed, a hardwire connection may be established between a given sensor and the green data acquisition system 250 via local interface/transceiver 258. A user interface 256 and memory 254 for storing green data obtained are coupled to processor 252. A transmitting/receiving device 257 coupled to processor 252 provides for unidirectional or bidirectional communication with mobile terminal 122.

The various sensors can include a sensor 264 that counts the number of times a refrigerator door is opened during a 24 hour period; a sensor 266 that records and averages the length of time that a refrigerator door is left open during a preset interval of time such as a 24 hour period, a sensor 268 that records the night time temperature of a bedroom during sleep time, a sensor that records the total wattage used during a 24 hour period, a sensor 272 that records the weight of garbage accumulated each week, and one or more sensors 274 for recording data from one or more green related events.

A visual representation of an individual's “green-ness” can be visually depicted in the form of an avatar such as a current form of the avatar, a past form of the avatar based on historical green data can be provided, and/or a future form of the avatar. Changes to the avatar in response to changes in the individual's green data over time can be visually depicted. Predictions based on historical green data can be performed to produce data used to develop a future form of the person's avatar. A single avatar or multiple avatars can be selectively presented for a display on the mobile or other computing device.

The system depicted in FIG. 2 generates a pollution impact (green) profile attributable to an individual. The pollution impact represented as part of the profile may be any one or other type(s) of pollution. For example, green profile can be expressed as carbon emission pollution. In addition to the various categories noted above, the following categories of pollution impact attributable to an individual can include a driving category, an air travel category, and other categories. It is understood that a green profile of an individual may have any number of green categories where each category may represent one or more pollution generation related activities. For example, a driving category may include an amount of carbon emission arising from activities related to operating an automobile. An air travel category may include an amount of carbon emission arising from activities related to travel by air. A home energy category may include, in addition to the categories noted previously such as related to monitoring energy efficiency, an amount of carbon emission arising from providing energy for heating with oil, gas or electricity. Another category may include an organizational activity shared with many individuals where the green data from the activity may include an amount of carbon emission by more than one person.

Each category may include data from one or more activities. For example, a driving category may be based on data that includes, but not limited to, the type of automobile driven, the gas mileage of the particular automobile model driven, the actual or estimated miles driven over a period of time, etc. Additionally, data from one source may have an impact on more than one category. For example, if no one is in the room, there will be an impact on both lighting and cooling or heating.

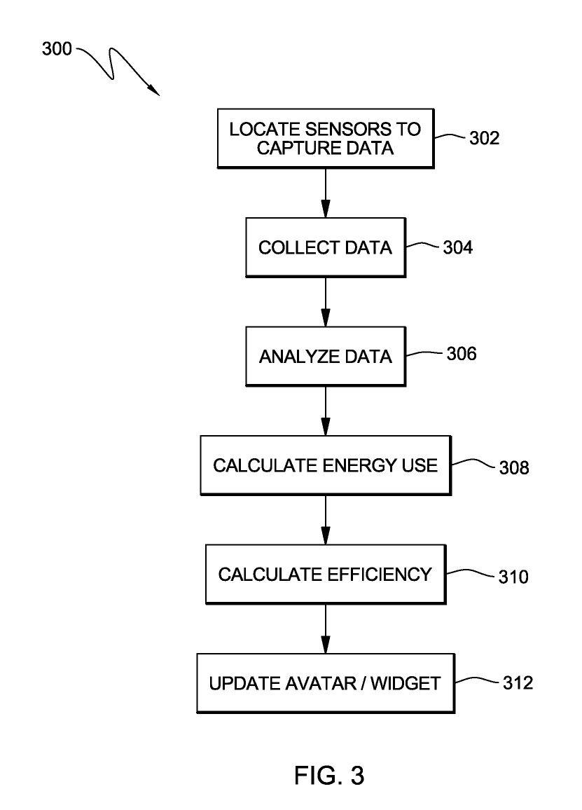

Referring to FIG. 3, there is shown a flow chart of one embodiment of a method 300 for motivating an individual to be more environmentally conscious, i.e., “green”, by causing for visualization by the user, a modification of his/her avatar, to result in promoting or modifying his/her use of energy, energy operated devices and/or creating less waste. Initially sensors are coupled to various devices to record events that affect the use of energy or the generation of one or more environmental pollutants, step 302. For example, in an individual's home, multiple sensors can be positioned to monitor various energy operated devices such as a heating system, a hot water boiler, the number of times a refrigerator door is opened and the length of time that it is open, the temperature of a bedroom during normal sleep hours, the temperature of a house during day time when no one is home, the energy used to light a room while the room is empty, the efficiency of various devices such as a furnace, refrigerator, air conditioner, etc., and the like. In one embodiment, device efficiency can be reported on by various organizations. For example, refrigerator efficiency is expressed by the ratio of the energy to cooled space yielding the unit kwh/cu.ft. For example, Energy Star lists the efficiency of hundreds of refrigerators and other home appliances. The ratio between monitored refractor efficiency to the data given by the Energy Star is equivalent to the ratio of power consumption for the same model. The larger the number, the poorer the performance. Frequently opening the refrigerator door will contribute to this low efficiency.

At step 304, data from each of the various sensors is collected and, by employing a “green engine” step 306 is implemented to analyze the data to identify energy operating devices that are not efficient and/or how a change in operation of a device may result in a device that will operate with reduced energy needs. For example, an analysis of the data may indicate that a furnace may need to be serviced because it operated continuously, not intermittently, for 6 hours when the outside temperature was only 41 degrees F. Analysis of the data, and the subsequent update of the profile and avatar, as noted in FIG. 3, may also indicate that a refrigerator is operating efficiently, but the door was left in an open position on numerous occasions for unusually long periods of time. Therefore, from the analysis of the data an individual can conclude that by closing the refrigerator door sooner, less energy will be used. As to the temperature of the bedroom, an analysis of the data may indicate that the thermostat was turned down to 60 degrees F. during normal sleep time and, therefore, this category is green and no change should be made. The sensor used to monitor the use of energy to light a room is coupled to a motion sensor that detects the presence and absence of a person in the room. In this category, an analysis of the data indicates that the lights in the room were on when nobody was in the room and, therefore, the room can become more green by either connecting the motion detector to control the lights in the room or that the lights are turned off when the last person leaves the room. An analysis of the data from each sensor as noted above can be by the green engine (employing a processor) or, by an individual. At step 308, the green engine processor determines total energy use of a particular time interval by processing data from the various sensors. The green engine processor can also calculate the efficiency of the various devices in the home for a time period of time, such as one month, step 310. Using this data, a Figure of Merit (FOM) for a predetermined or programmed time interval, e.g., a month can be obtained. The FOM can have a range of 1 to 10, or 1 to 100 where the range is directly related to the green efficiency of the home. Efficiency is a ratio against a benchmark. For example, the total energy consumed is transformed into carbon dioxide. The home emissions are C tons of Carbon dioxide a year. The average home emissions are D in the same year (compared with the same house, the same number of people in the house, etc). The saving would be (D-C)/D. A higher number means less Carbon emissions. For example, if the FOM is related to the efficiency, then when the efficiency is 63%, the FOM will have a value of 63 for the time interval, e.g., month, that the data was obtained. The value of the FOM is used to generate and/or update an Avatar, a social networking widget, an electronic/virtual display and/or other output/record, step 312. The FOM can also be used to generate a coupon, a voucher and/or a credit having a value determined by the value of the FOM.

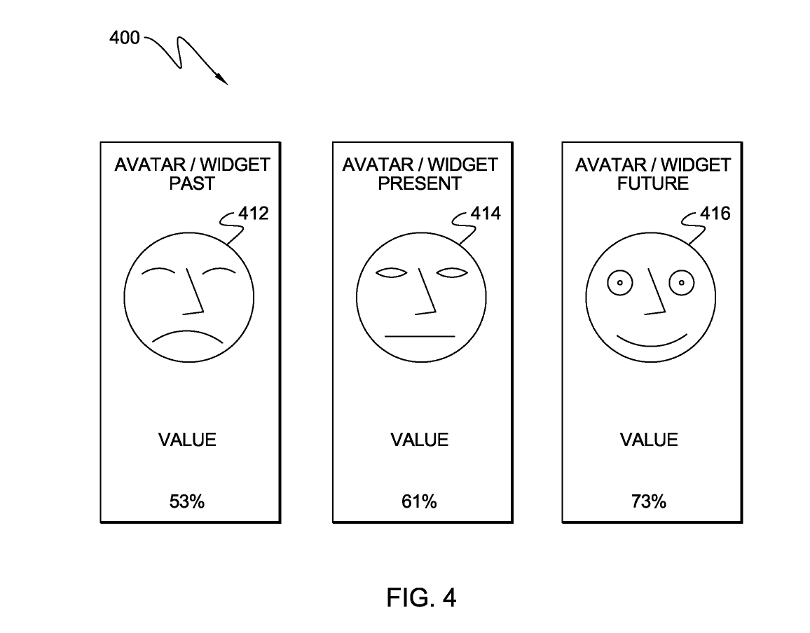

Referring to FIG. 4, there is depicted a display 300 on which various types of green data within the context of the present invention are displayed. The display 400 represents a display of a mobile terminal, a television, a WEB terminal device, or the display of another access device. Various textual data can be shown, including the data types acquired by the green data acquisition system and user input data, such as energy used, for example. Current green data generated by the green data engine can be presented on the display. Historical green data can also be presented on the display. Predicted green data generated by the green data engine can be presented.

A visual representation of the user and user's use of green data is graphically presented on the display such as the example display 400 in one embodiment a shown is FIG. 4. Various green data of the user can be visually depicted in the form of an avatar. The present form of the avatar 414 can be displayed, as can a past avatar form 412 based on historical fitness data. Changes to the avatar in response to changes in the user's green data over time can be visually depicted. Predictions based on historical green data can be performed to produce data used to develop a future form of the user's avatar 416. Single or multiple avatars can be selectively generated for presentation on the display 400 by a user.

This invention consolidates the results of various measures of “green-ness”, and provides an avatar/widget that can be displayed on a display, e.g., such as may be associated with a mobile device, a social networking site, used with avatars/widgets in virtual worlds, or, be added to an e-mail signature, etc. The value collected/shown by the avatar/widget could also be potentially be used to trade carbon offsets or provide credit for future rationing coupons. “Points” can be added to the avatar/widget from various sources: home energy meters, PDA interfaces that can collect mobile carbon use information from various sensors (e.g.: board a bus and have points added vs. driving). Individuals could also show their points on t-shirts, bumper stickers, and other motivational items.

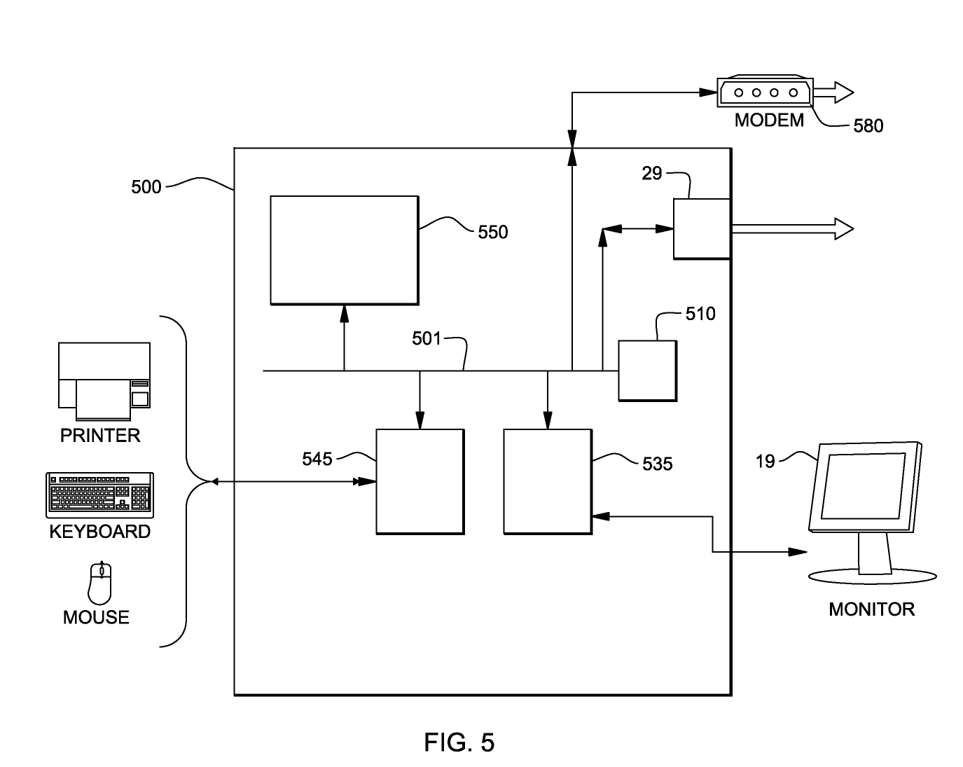

A computer-based system 500 is depicted in FIG. 5 herein by which the method of the present invention may be carried out. Computer system 500 includes a processing unit, which houses a processor, memory and other systems components that implement a general purpose processing system or computer that may implement a computer program product. The computer program product may comprise media, for example a compact storage medium such as a compact disc, which may be read by the processing unit through a disc drive, or by any means known to the skilled artisan for providing the computer program product to the general purpose processing system for implementation thereby.

The computer program product comprises all the respective features enabling the implementation of the methods described herein, and which—when loaded in a computer system—is able to carry out these methods. Computer program, software program, program, or software, in the present context means any expression, in any language, code or notation, of a set of instructions intended to cause a system having an information processing capability to perform a particular function either directly or after either or both of the following: (a) conversion to another language, code or notation; and/or (b) reproduction in a different material form.

The computer program product may be stored on hard disk drives within processing unit (as mentioned) or may be located on a remote system such as a server (not shown), coupled to processing unit, via a network interface such as an Ethernet interface. Monitor, mouse and keyboard are coupled to the processing unit, to provide user interaction. Printer is shown coupled to the processing unit via a network connection, but may be coupled directly to the processing unit.

More specifically, as shown in FIG. 5, the computer system 500, includes one or more processors or processing units 510, a system memory 550, and an address/data bus structure 501 that connects various system components together. For instance, the bus 501 connects the processor 510 to the system memory 550. The bus 501 can be implemented using any kind of bus structure or combination of bus structures, including a memory bus or memory controller, a peripheral bus, an accelerated graphics port, and a processor or local bus using any of a variety of bus architectures such as ISA bus, an Enhanced ISA (EISA) bus, and a Peripheral Component Interconnects (PCI) bus or like bus device. Additionally, the computer system 500 includes one or more monitors 19 and, operator input devices such as a keyboard, and a pointing device (e.g., a “mouse”) for entering commands and information into computer, data storage devices, and implements an operating system such as Linux, various Unix, Macintosh, MS Windows OS, or others.

The computing system 500 additionally includes: computer readable media, including a variety of types of volatile and non-volatile media, each of which can be removable or non-removable. For example, system memory 550 includes computer readable media in the form of volatile memory, such as random access memory (RAM), and non-volatile memory, such as read only memory (ROM). The ROM may include an input/output system (BIOS) that contains the basic routines that help to transfer information between elements within computer device 500, such as during start-up. The RAM component typically contains data and/or program modules in a form that can be quickly accessed by processing unit. Other kinds of computer storage media include a hard disk drive (not shown) for reading from and writing to a non-removable, non-volatile magnetic media, a magnetic disk drive for reading from and writing to a removable, non-volatile magnetic disk (e.g., a “floppy disk”), and an optical disk drive for reading from and/or writing to a removable, non-volatile optical disk such as a CD-ROM, DVD-ROM, or other optical media. Any hard disk drive, magnetic disk drive, and optical disk drive would be connected to the system bus 501 by one or more data media interfaces (not shown). Alternatively, the hard disk drive, magnetic disk drive, and optical disk drive can be connected to the system bus 501 by a SCSI interface (not shown), or other coupling mechanism. Although not shown, the computer 500 can include other types of computer readable media. Generally, the above-identified computer readable media provide non-volatile storage of computer readable instructions, data structures, program modules, and other data for use by computer 500. For instance, the readable media can store an operating system (O/S), one or more application programs, such as video editing client software applications, and/or other program modules and program data for enabling video editing operations via Graphical User Interface (GUI). Input/output interfaces 545 are provided that couple the input devices to the processing unit 510. More generally, input devices can be coupled to the computer 500 through any kind of interface and bus structures, such as a parallel port, serial port, universal serial bus (USB) port, etc. The computer environment 500 also includes the display device 19 and a video adapter card 535 that couples the display device 19 to the bus 501. In addition to the display device 19, the computer environment 500 can include other output peripheral devices, such as speakers (not shown), a printer, etc. I/O interfaces 545 are used to couple these other output devices to the computer 500.

As mentioned, computer system 500 is adapted to operate in a networked environment using logical connections to one or more computers, such as a server device that may include all of the features discussed above with respect to computer device 500, or some subset thereof. It is understood that any type of network can be used to couple the computer system 500 with server device, such as a local area network (LAN), or a wide area network (WAN) (such as the Internet). When implemented in a LAN networking environment, the computer 500 connects to local network via a network interface or adapter 29. When implemented in a WAN networking environment, the computer 500 connects to a WAN via a high speed cable/dsl modem 580 or some other connection means. The cable/dsl modem 580 can be located internal or external to computer 500, and can be connected to the bus 501 via the I/O interfaces 545 or other appropriate coupling mechanism. Although not illustrated, the computing environment 500 can provide wireless communication functionality for connecting computer 500 with remote computing device, e.g., an application server (e.g., via modulated radio signals, modulated infrared signals, etc.).

Although an example of the present invention has been shown and described, it would be appreciated by those skilled in the art that changes might be made in the embodiment without departing from the principles and spirit of the invention, the scope of which is defined in the claims and their equivalents.

What is claimed is:

1. A method of generating for display on a computer device, a resource utilization and efficiency value of a residence or business comprising:
monitoring at least one energy using device associated with an environment for obtaining operating data in a predetermined time interval;
analyzing said operating data obtained during said predetermined interval of time for obtaining a value of energy used by said at least one energy using device;
calculating an efficiency value from the value of energy used during the predetermined interval of time; and
creating, based on said efficiency value, a computer generated image that represents said calculated efficiency value for the predetermined interval of time for display on the computer screen,
using a processor to perform one or more of said analyzing, calculating and creating steps.

2. The method of claim 1 further comprising:
using said efficiency value for providing an avatar computer generated caricature that represents the calculated efficiency value of the at least one energy using device; wherein said computer generated caricature is distinct for said value of efficiency.

3. The method of claim 1 further comprising:
using said efficiency value for providing a computer generated widget that represents the calculated efficiency value of the at least one energy using device; wherein said computer generated widget is distinct for said value of efficiency.

4. The method of claim 1 further comprising:
using said efficiency value for providing a computer generated avatar or widget that represents the calculated efficiency value of the at least one energy using device for a predetermined interval of time; wherein said computer generated avatar or widget is distinct for said value of efficiency.

5. The method of claim 4 further comprising:
monitoring energy used by lights in at least one room in the home to obtain data of power being used;
monitoring the room for the absence of a person in said room when said lights are on;
analyzing the data of power used by the lights when the room was not occupied during a predetermined interval of time;
analyzing the data of power used by the lights when the room was occupied during said predetermined interval of time;
calculating efficiency values, a first from the value of energy used when the lights were on and the room was not occupied, and a second from the value of energy used when the lights were on and the room was occupied;
obtaining a efficiency value from said first and second efficiency values; and
using said efficiency value to generate a discrete avatar or widget that represents said efficiency for a predetermined interval of time for display on a computer screen.

6. The method of claim 4 wherein said avatar or widget is a face having a first expression indication a first efficiency and that changes to a second expression as the efficiency increases.

7. The method of claim 6 further comprising:
generating a discrete avatar or widget of a prior predetermined interval of time for display with said discrete avatar or widget.

8. The method of claim 7 further comprising:
estimating a discrete avatar or widget for a subsequent predetermined interval of time for display with said discrete avatar or widget.

9. The method of claim 8 further comprising:
displaying for user's visualization said avatars or widgets for said prior, current and estimated predetermined intervals of time.

10. The method of claim 6 further comprising:
identifying said avatar or widget with an actual efficiency value designation.

11. A system of generating for display on a computer device, a resource utilization and efficiency value of a residence or business comprising:
a sensor for monitoring at least one energy using device associated with said residence or business for obtaining operating data;
means for analyzing said operating data obtained during a predetermined interval of time for obtaining a value of energy used by said at least one energy using device;
means for calculating an efficiency value from the value of energy used during the predetermined interval of time; and
means for using said efficiency value to create a computer generated image that represents said calculated efficiency value for a predetermined interval of time for display on the computer device.

12. The system of claim 11 further comprising:
means for using said efficiency value for providing an avatar computer generated caricature that represents the calculated efficiency value of the at least one energy using device; wherein said computer generated caricature is distinct for said value of efficiency.

13. The system of claim 11 further comprising:
means for using said efficiency value for providing a computer generated widget that represents the calculated efficiency value of the at least one energy using device; wherein said computer generated widget is distinct for said value of efficiency.

14. The system of claim 11 further comprising:
means for using said efficiency value for providing a computer generated avatar or widget that represents the calculated efficiency value of the at least one energy using device for a predetermined interval of time; wherein said computer generated avatar or widget is distinct for said value of efficiency.

15. The system of claim 14 further comprising:
a sensor for monitoring energy used by lights in at least one room in the home to obtain data of power being used;
a sensor for monitoring the room for the absence of a person in said room when said lights are on;
means for analyzing the data of power used by the lights when the room was not occupied during a predetermined interval of time;
means for analyzing the data of power used by the lights when the room was occupied during said predetermined interval of time;
means for calculating efficiency values, a first from the value of energy used when the lights were on and the room was not occupied, and a second from the value of energy used when the lights were on and the room was occupied;
means for obtaining a efficiency value from said first and second efficiency values; and
means for using said efficiency value to generate a discrete avatar or widget that represents said efficiency for a predetermined interval of time for display on a computer screen.

16. The system of claim 14 wherein said avatar or widget is a face having a first expression indication a first efficiency and that changes to a second expression as the efficiency increases.

17. The system of claim 16 further comprising:
means for generating a discrete avatar or widget of a prior predetermined interval of time for display with said discrete avatar or widget.

18. The system of claim 17 further comprising:
means for estimating a discrete avatar or widget for a subsequent predetermined interval of time for display with said discrete avatar or widget.

19. The system of claim 18 further comprising:
means for displaying for user's visualization said avatars or widgets for said prior, current and estimated predetermined intervals of time.

20. The system of claim 16 further comprising:
means for identifying said avatar or widget with an actual efficiency value designation.

21. A computer program product for generating a display representing a resource utilization and efficiency value of a residence or business, the computer program product comprising:
a storage medium readable by a processing circuit and storing instructions for operation by the processing circuit for performing a method comprising:
monitoring at least one energy using device associated with an environment for obtaining operating data in a predetermined time interval;
analyzing said operating data obtained during said predetermined interval of time for obtaining a value of energy used by said at least one energy using device;
calculating an efficiency value from the value of energy used during the predetermined interval of time; and
creating, based on_said efficiency value, a computer generated image that represents said calculated efficiency value for the predetermined interval of time for display on the computer screen

22. The computer program product of claim 21 further comprising:
using said efficiency value for providing an avatar computer generated caricature that represents the calculated efficiency value of the at least one energy using device; wherein said computer generated caricature is distinct for said value of efficiency.

23. The computer program product of claim 21 further comprising:
using said efficiency value for providing a computer generated widget that represents the calculated efficiency value of the at least one energy using device; wherein said computer generated widget is distinct for said value of efficiency.

24. The computer program product of claim 21 further comprising:
using said efficiency value for providing a computer generated avatar or widget that represents the calculated efficiency value of the at least one energy using device for a predetermined interval of time; wherein said computer generated avatar or widget is distinct for said value of efficiency.

25. The computer program product of claim 24 further comprising:
monitoring energy used by lights in at least one room in the home to obtain data of power being used;
monitoring the room for the absence of a person in said room when said lights are on;
analyzing the data of power used by the lights when the room was not occupied during a predetermined interval of time;
analyzing the data of power used by the lights when the room was occupied during said predetermined interval of time;
calculating efficiency values, a first from the value of energy used when the lights were on and the room was not occupied, and a second from the value of energy used when the lights were on and the room was occupied;
obtaining an efficiency value from said first and second efficiency values; and
using said efficiency value to generate a discrete avatar or widget that represents said efficiency for a predetermined interval of time for display on a computer screen.

26. The computer program product of claim 24 wherein said avatar or widget is a face having a first expression indication a first efficiency and that changes to a second expression as the efficiency increases.

27. The computer program product of claim 26 further comprising:
generating a discrete avatar or widget of a prior predetermined interval of time for display with said discrete avatar or widget.

28. The computer program product of claim 27 further comprising:
estimating a discrete avatar or widget for a subsequent predetermined interval of time for display with said discrete avatar or widget.

29. The computer program product of claim 28 further comprising:
displaying for user's visualization said avatars or widgets for said prior, current and estimated predetermined intervals of time.

30. The computer program product of claim 26 further comprising:
identifying said avatar or widget with an actual efficiency value designation.
